(19) United States
(12) Patent Application Publication
(10) Pub. No.: US 2026/0128561 A1
(43) Pub. Date: May 7, 2026

(54) COIL SPRING CASSETTE

(71) Applicant: KOSTAL Automobil Elektrik GmbH & Co. KG, Lüdenscheid (DE)

(72) Inventors: Knut Moldenhauer, Hagen (DE); Christian Hess, Lüdenscheid (DE); Renè Priebe, Lüdenscheid (DE)

(73) Assignee: KOSTAL Automobil Elektrik GmbH & Co. KG, Lüdenscheid (DE)

(21) Appl. No.: 19/439,210

(22) Filed: Jan. 2, 2026

Related U.S. Application Data
(63) Continuation of application No. PCT/EP2024/068621, filed on Jul. 2, 2024.

(30) Foreign Application Priority Data
Jul. 4, 2023 (DE) 102023117656.0

(51) Int. Cl. H01R 35/02

(52) U.S. Cl. CPC H01R 35/025

(57) ABSTRACT

A coil spring cassette includes a stator housing part and a rotor housing part, between which a winding gap is formed. A flexible flat cable having an electrical conductor and a flexible flat ribbon are arranged in the winding gap and are wound in opposite directions so that a respective first section of the cable and ribbon rests against an inner surface of the stator housing part and a respective second section rests against an outer surface of the rotor housing part with a U-shaped turning section which reverses the winding direction is formed in each case between the two respective sections of the cable and the ribbon. The ribbon is a thin steel strip, and a permanent magnet is mounted in the region of the outer surface of the rotor housing part such that the permanent magnet exerts an attractive effect on the ribbon section resting thereon.

### CROSS-REFERENCE TO RELATED APPLICATIONS

This application is a continuation of International Application No. PCT/EP2024/068621, published in German, with an international filing date of Jul. 2, 2024, which claims priority to DE 10 2023 117 656.0, filed Jul. 4, 2023, the disclosures of which are hereby incorporated in their entirety by reference herein.

### TECHNICAL FIELD

The present invention relates to a coil spring cassette including a stationary, at least partially cylindrical stator housing part and a cylindrical rotor housing part that is situated coaxially with respect to same and rotatable about its longitudinal axis, wherein a winding gap that is delimited by the inner lateral surface of the cylindrical portion of the exterior stator housing part and the outer lateral surface of the interior rotor housing part is formed, in which a flexible flat cable having at least one electrical conductor, and at least one flexible flat ribbon used for mechanical stabilization of the flat cable, are arranged in such a way that their respective first ends are fastened to the stator housing part and their respective second ends are fastened to the rotor housing part, and are wound in opposite directions with a respective first section of their length resting against the inner lateral surface of the stator housing part and with a respective second section of their length resting against the outer lateral surface of the rotor housing part, so that a U-shaped turning section which reverses the winding direction is formed in each case between the two respective sections of the flat cable and of the flat ribbon.

### BACKGROUND

These types of coil spring cassettes are provided, for example, to allow reliable transfer of energy and/or data in motor vehicles, between connection points that are rotatably mounted in the steering wheel and connection points that are stationarily situated in the area of the steering column. Via the connection points of such a device, an airbag system, a steering wheel heating unit, a switching mechanism, etc., may be supplied with the voltage and signals necessary for them to function.

Such a coil spring cassette has become known from EP 0 556 779 B1 (corresponding to U.S. Pat. No. 5,310,356), in which multiple flexible flat cables are accommodated inside an annular cavity in a housing. In each case, one end of the flexible flat cables is fastened to the stator part, and the respective other end of the flexible flat cables is fastened to a rotor part of the housing which is rotatable relative to the stator part. The flexible flat cables, with each of their two broad sides, are windable with at least one winding onto the axially oriented inner wall, and at a distance therefrom, are oppositely windable onto the axially oriented inner outer wall of the housing with at least one further winding, in each case via a U-shaped turning section.

If a plurality of flat cables is needed for providing the required electrical connections, this plurality of flat cables is arranged in such a way that their respective end sections overlap on the outer lateral surface of the interior housing part and on the inner lateral surface of the exterior housing part, and the U-shaped turning sections of each of the flat cables generates an elastic pressure force that brings about secure contact of the internally or externally wound areas of the other flat cables with the lateral surfaces of the housing.

If the number of flat cables needed for providing the required electrical connections is smaller than necessary for ensuring proper mechanical functioning of the coil spring cassette, so-called dummy cables are used instead of further flat cables. Dummy cables are elastic flat ribbons having mechanical properties equivalent to the flat cables, except that the former have no electrical strip conductors. Plastic ribbons made of PET, for example, are normally used as dummy cables. In practical operation, use of at least four or five cables or dummy cables has proven advantageous to ensure proper mechanical functioning of the coil spring cassette. These four or five cables or dummy cables must be arranged in such a way that their U-shaped turning sections which reverse the winding direction are distributed as uniformly as possible over the circumference of the winding gap.

In steering assemblies according to the so-called steer-by-wire principle, in which a mechanical steering spindle is no longer present, the steering wheel no longer has to be rotatable over multiple revolutions. Rotatability of even less than 360 degrees is necessary as a rule, which for the coil spring cassette means that it no longer has to encompass the entire steering spindle. Thus, the housing of the coil spring cassette no longer has to have a completely ring-shaped cross section. Rather, it is sufficient for the housing to form only a segment of a ring, thus providing additional installation space in this area in comparison to the background art.

However, when multiple flat cables are required, they must then be arranged much closer to one another, so that the above-described mechanical stabilization via the U-shaped turning sections of the flat cables uniformly distributed over the circumference is no longer possible. It has been shown that, in particular in the vicinity of the connection of the flat cables to the interior rotor housing part, the flat cables no longer rest securely against the outer lateral surface of this rotor housing part.

### SUMMARY

Therefore, a different form of mechanical stabilization is necessary which provides the coil spring cassette according to the present invention in a simple and robust manner.

This is achieved according to the present invention in that the at least one flat ribbon is designed as a thin steel strip, and at least one permanent magnet is mounted in the region of the outer lateral surface of the rotor housing part in such a way that the permanent magnet exerts an attractive effect on the second section of the length of the flat ribbon resting thereon.

### BRIEF DESCRIPTION OF THE DRAWINGS

One advantageous embodiment of the subject matter according to the present invention is explained in greater detail based one exemplary embodiment illustrated in the drawings, which show the following:

FIG. 1 shows a schematic illustration of one embodiment of a coil spring cassette according to the present invention in cross section; and

FIG. 2 shows a schematic illustration of a coil spring cassette according to the background art in cross section.

### DETAILED DESCRIPTION

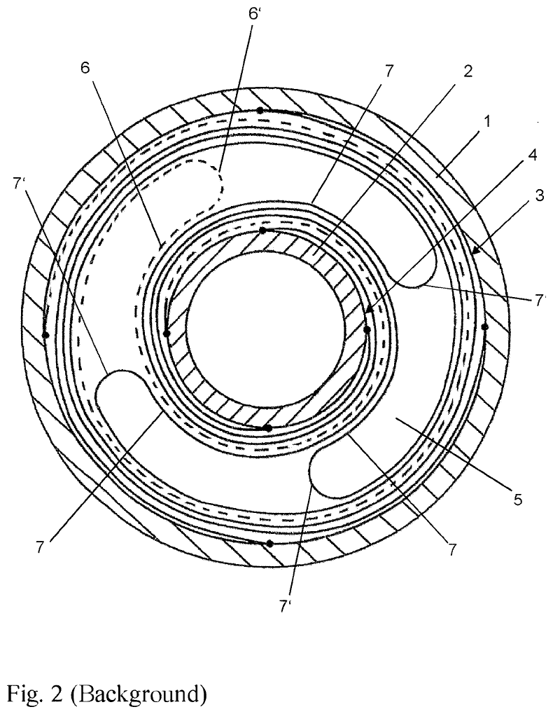

For explaining the general operating principle of the coil spring cassette in question, a coil spring cassette according to the background art having the above-mentioned minimum number of four cables or dummy cables is schematically illustrated in cross section in FIG. 2. This coil spring cassette is made up essentially of a housing that includes a stator housing part 1 and a rotor housing part 2, and flexible flat cables 6 and flat ribbons 7 as dummy cables inside an annular cavity in the housing which forms a winding gap 5. In the known embodiment shown here, three flexible flat ribbons 7 without electrical conductors, and one electrical flat cable 6 are present. Flat cable 6 is illustrated by dashed lines in FIG. 2.

Interior rotor housing part 2 in the illustrated embodiment is rotatable about its own longitudinal axis, and thus, about stator housing part 1 situated coaxially with respect to the rotor housing part. Inner lateral surface 3 of stator housing part 1 and outer lateral surface 4 of rotor housing part 2 form a winding gap 5 which accommodates flexible flat cable 6. Flexible flat cable 6 with its first end is fastened to stator housing part 1, and with its second end is fastened to rotor housing part 2, and is thus situated in winding gap 5 in such a way that it is wound with a section of its length adjoining its first end resting against inner lateral surface 3 of stator housing part 1, and in the opposite direction is wound with a section of its length adjoining its second end resting against outer lateral surface 4 of rotor housing part 2. Situated between the respective two sections of flat cable 6 is a U-shaped turning section 6′ which reverses the winding direction thereof. When rotor housing part 2 rotates in one direction or the other, U-shaped turning section 6′ moves along the circumference of winding gap 5, and flat cable 6 is unwound on its one side and is unwound on its other side. For mechanical stabilization of flat cable 6, in particular to ensure that the end sections thereof rest securely against lateral surfaces 3, 4, three elastic flat ribbons 7 are additionally accommodated in winding gap 5 in the same way as flat cable 6, in particular in such a way that the four U-shaped turning sections 6′, 7′ of the one flat cable 6 and of the three flat ribbons 7 are situated at the same angular distance of approximately 90° relative to one another. In addition, the respective first and second ends of flat ribbon 6 and of flat ribbons 7, which are fastened on the one hand to stator housing part 1 and on the other hand to rotor housing part 2, in each case assume the same angular distance of approximately 90° relative to one another.

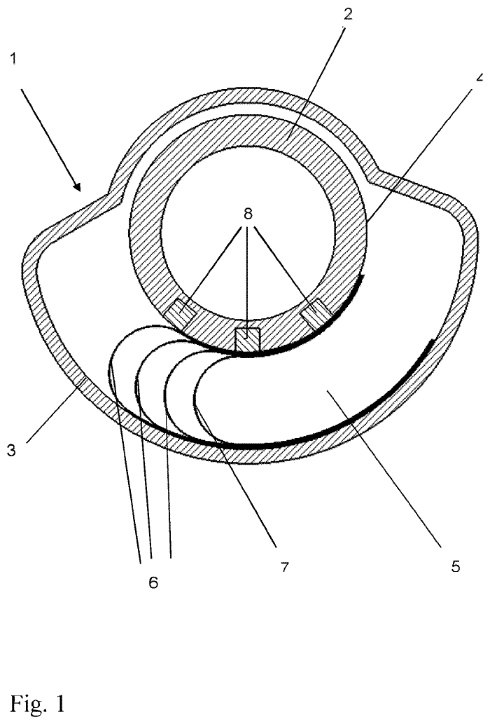

In the coil spring cassette according to the present invention shown in FIG. 1, whose housing no longer has a completely ring-shaped cross section, but instead forms only a segment of a ring, flat cables 6 and flat ribbons 7 must be arranged in a different way. The respective first and second ends of flat cables 6 and of the only one flat ribbon 7 in this case are each fastened at the same location on stator housing part 1 on the one hand, and on rotor housing part 2 on the other hand. In contrast to the embodiment according to the background art described above, in which all flat cables 6 and flat ribbons 7 may have essentially the same length, at least in theory, in this case their lengths must necessarily be different. Flat ribbon 7 on the interior with respect to winding gap 5 has the shortest length. Flat cable 6 on the exterior with respect to winding gap 5 is the longest, and in this embodiment is also the only flat cable that rests directly against inner lateral surface 3 of stator housing part 1 and also against outer lateral surface 4 of rotor housing part 2.

According to the present invention, flat ribbon 7 on the interior with respect to winding gap 5 is designed as a thin steel strip and is used solely for mechanical stabilization of flat cables 6. Permanent magnets 8 are mounted in the region of outer lateral surface 4 of rotor housing part 2 in such a way that the permanent magnets exert an attractive effect on the section of the length of flat ribbon 7 resting thereon. The regions of flat cables 6 situated between flat ribbon 7 and outer lateral surface 4 of rotor housing part 2 are thus fixed by flat ribbon 7 to outer lateral surface 4 of rotor housing part 2. The thickness and extent of the region of the attractive effect on flat ribbon 7 may be changed via the number and strength of permanent magnets 8 used. An adaptation may thus be made, for example, to different maximum rotational angle ranges or a different number of flat cables 6 that are present. Three permanent magnets 8 are present in the embodiment shown here.

What is claimed is:

1. A coil spring cassette comprising:
a partially cylindrical stator housing part, the stator housing part being partially cylindrical in that the stator housing part includes a cylindrical housing part portion and a non-cylindrical housing part portion;
a cylindrical rotor housing part;
the rotor housing part is situated coaxially with respect to the stator housing part and the rotor housing part is rotatable relative to the stator housing part;
a winding gap between by an inner surface of the cylindrical housing part portion of the stator housing part and an outer surface of the rotor housing part;
a flexible flat cable having at least one electrical conductor;
a flexible flat ribbon used for mechanical stabilization of the flat cable;
the flat cable and the flat ribbon are arranged in the winding gap in such a way that their respective first ends are fastened to the stator housing part and their respective second ends are fastened to the rotor housing part and are wound in opposite directions with a respective first section of their length resting against the inner surface of the cylindrical housing part portion of the stator housing part and with a respective second section of their length resting against the outer surface of the rotor housing part, so that a U-shaped turning section which reverses the winding direction is formed in each case between the two respective sections of the flat cable and of the flat ribbon;
wherein the flat ribbon is a thin steel strip; and
a permanent magnet is mounted in a region of the outer surface of the rotor housing part in such a way that the permanent magnet exerts an attractive effect on the second section of the length of the flat ribbon resting thereon.
